(19) United States
(12) Patent Application Publication
(10) Pub. No.: US 2026/0363385 A1
(43) Pub. Date: Nov. 19, 2026

(54) ARTICLE OF ORTHOPEDIC FOOTWEAR

(71) Applicants: CENTRE HOSPITALIER UNIVERSITAIRE VAUDOIS (CHUV), Lausanne (CH); ECOLE POLYTECHNIQUE FEDERALE DE LAUSANNE (EPFL), Lausanne (CH)

(72) Inventors: Julien Favre, Epalinges (CH); Brigitte Jolles-Haeberli, Belmont-sur-Lausanne (CH); Baptiste Ischer, Naz (CH); Charles Baur, Sauges (CH); José Luis Rivera Gutiérrez, Yverdon (CH); Laurent Hoffmann, Remetschwil (CH)

(21) Appl. No.: 19/137,040

(22) PCT Filed: Dec. 8, 2023
(86) PCT No.: PCT/EP2023/084976

§ 371 Date: Jun. 9, 2025

(30) Foreign Application Priority Data
Dec. 9, 2022 (EP) 22212669.0

(51) Int. Cl. A43B 13/12; A43B 7/1455; A43B 13/18; A43B 17/00; A43B 17/02

(52) U.S. Cl. CPC A43B 13/127; A43B 7/147; A43B 13/188; A43B 17/006; A43B 17/02

(57) ABSTRACT

The present invention relates to an article of orthopedic footwear comprising a sole. The sole comprises an outsole, an insole comprising a support layer for supporting the foot of a user, the support layer possibly comprising a rigid plate and having a lower surface. The sole further comprises a midsole having a compression portion positioned below the lower surface of the support layer, and a joint portion positioned on either the medial side or the lateral side of the lower surface of the support layer. The joint portion allows the support layer to pivot about the joint portion when subjected to a locomotion force such that the compression portion is compressed.

### CROSS-REFERENCE TO RELATED APPLICATION(S)

The present application is a § 371 National Phase Entry of International patent application Serial No. PCT/EP2023/084976, filed Dec. 8, 2023, and further claims priority to European patent application number 22212669.0, filed Dec. 9, 2022.

### BACKGROUND

The invention relates to an article of orthopedic footwear.

Knee osteoarthritis (OA) is one of the most common musculoskeletal diseases worldwide, with tens of millions of people affected in Europe alone. This disease is among the leading causes of disability and induces pain, stiffness and loss of function at the joint. It also represents a real economic burden for society with annual costs estimated, in Europe alone, at over one hundred billion euros. With the aging of the population and the increase of obesity prevalence, knee OA prevalence increased significantly during the last decades and is expected to continue increasing in the future. The knee joint is affected non uniformly with OA. Indeed, the medial compartment is more often affected, partially due to the uneven mechanical loading between the medial and lateral compartments.

Currently, no cure exists for knee OA and the disease end-stage often leads to major surgery with total joint arthroplasty. Therefore, there is a need for better management of the disease to avoid reaching end-stage OA, or at least to slow down disease progression and reduce associated symptoms. While knee OA is far from being fully understood, the ambulatory function of the joint, specifically the repetitive mechanical stress, has been shown to play an important role in the progression of medial compartment knee OA. These observations lead to the design of methods to modify the walking pattern based on footwear, braces or retraining. Symptom reductions have been reported with these interventions, supporting their potential. However, effective solutions are missing in routine practice.

It is desired to provide an article of orthopedic footwear which provides an improvement over known processes and addresses the problems described.

### SUMMARY

According to a first aspect, the invention relates to an article of orthopedic footwear having a sole, the sole comprising: an outsole which forms at least a portion of the ground-contacting surface of the footwear article; an insole comprising a support layer for supporting the foot of a user; and a midsole positioned between and/or separating the support layer from the outsole and comprising a compression portion having a first hardness and being positioned below a lower surface of the support layer; and a joint portion being affixed on one of the medial side and the lateral side of the lower surface of the support layer, the joint portion being configured to allow the support layer to pivot about the joint portion when subjected to a locomotion force such that the compression portion is compressed.

The support layer may comprise a rigid plate. The rigid plate may be constructed of metal, plastic, cellulose, acetal, acrylic, high-density polyethylene, polycarbonate, carbon fiber, or ceramic.

Optionally, the joint portion has a second hardness greater than the first hardness.

Optionally the joint portion has a hardness of at least 80 Shore A, optionally at least 90 Shore A, optionally at least 100 Shore A.

In some embodiments, the joint portion is configured to be essentially incompressible. Such hardness and/or incompressible configuration has been found advantageous to achieve the desired pivoting via the joint.

The joint portion is positioned such that the support layer may be enabled to pivot in a medial-lateral direction and in an anterior-posterior direction. Pivoting enabled by the joint may allow changing ambulatory biomechanics. For example, in the case of medial compartment knee osteoarthritis the pivoting could change the loading throughout the joint to protect it against the disease.

The support layer optionally is more rigid and/or stiff than the midsole. The support layer optionally is more rigid and/or stiff than the outsole. Alternatively, in some configurations the support layer may be at least as rigid and/or stiff as the joint portion. A rigid support layer may aid in controlling the pivoting to address gait problems.

The joint portion may comprise one or more of a ball joint, an accordion, a bellows joint, a saddle joint, a condyloid joint, an elastic joint and/or hinge joint. The type of joint may be selected based on the desire for medial-lateral and/or anterior-posterior pivoting.

The compression portion may have a hardness between 10 Shore A and 90 Shore A, optionally between 20 Shore A and 85 Shore A, optionally between 30 Shore A and 80 Shore A. The joint portion may be more rigid and/or stiff than the compression portion.

The article may further comprise an upper which is attached to the sole at the midsole or the outsole. Optionally, the upper is not attached directly to the insole.

The support layer optionally defines a support plane. The support plane may have a neutral position when the support layer is not subjected to a locomotion force. When the support layer is subjected to a locomotion force the support plane optionally pivots by a pivoting angle of at least 1°, optionally at least 3°, optionally at least 5° from the neutral position. The neutral position may be parallel to the ground. Optionally, the support plane is tangent to the support layer. Optionally, the locomotion force may be between 0.6 and 5.0 times the bodyweight of the wearer. Alternatively, the locomotion force may be between 400 N and 6000 N, optionally between 500 N and 5000 N.

The locomotion force may be applied to at least one of a forefoot area, a midfoot area, or a heel area of the support layer and/or sole, optionally wherein the locomotion force is applied during a stride of a person. The desired pivoting behavior of the article determines which area of the support layer and/or article where the force should be applied.

Optionally, when a standing force is applied to the support layer during standing of a person, the standing force causes the support plane to pivot by a pivoting angle of at most 10°, optionally at most 5°, optionally at most 3°, optionally the support plane remains in a neutral position. In other words, the support layer may be configured to not pivot, or to pivot only slightly (e.g., by a pivoting angle of at most 10°, optionally at most 5°, optionally at most 3°), when the patient stands, whereas the support layer may be configured to pivot substantially during one or more phases of a gait cycle (such as a pivoting angle of at least 1°, optionally at least 3°, optionally at least 5° from the neutral position), such as one or more of a loading response phase, a midstance phase, a terminal stance phase, and a pre-swing phase of the respective foot. The standing force may be between 0.4 and 0.6 times the bodyweight of the wearer. Alternatively, the standing force may be between 150 N and 700 N, optionally between 200 N and 500 N.

The joint portion may define a pivot axis, and the support plane pivots by the pivoting angle about the pivot axis. Optionally, the pivot axis is positioned within 3 cm, optionally within 2 cm, optionally within 1 cm of an edge of the insole, optionally wherein the pivot axis extends along the lateral side or the medial side, optionally wherein the edge is a lateral edge or a medial edge of the insole. The lateral or medial edge may also be referred to as the lateral or medial end of the insole, or the lateral or medial boundary of the insole, respectively, in the context of the present invention.

The support plane may extend through the pivot axis and/or the support plane is tangent to the lower surface of the support layer. Optionally, the support plane in the neutral position is parallel to the ground and the support plane forms the pivoting angle with respect to the ground.

Optionally, when the support layer is subjected to the locomotion force, the pivoting angle is within the range of 1° to 20°, optionally within the range of 3° to 15°, and optionally within the range of 5° to 12°.

The rigid plate of the support layer may be configured to deform less than 8 mm, optionally 5 mm, optionally 3 mm when subjected to a pressure of 10 N per square centimeter.

The joint portion may be formed from a different material than the support layer.

The support layer may be injection molded, 3D printed, or milled. The support layer may be made from fiber reinforced plastics, recycled material, cardboard, metal, plastic, cellulose, acetal, acrylic, high-density polyethylene, polycarbonate, carbon fiber, and/or ceramic.

The first hardness of the compression portion may vary spatially.

The compression portion and the joint portion may be formed from a single midsole material, optionally wherein the midsole is formed by 3D printing. This enables a single step fabrication of the midsole while still achieving the pivoting angle necessary to change ambulatory biomechanics. For example, the midsole may be formed as a 3D printed, three-dimensional network. A lower material density (e.g., by forming a more open network) and/or a softer configuration of the material may be used in the compression portion and a higher material density and/or a harder configuration of the material may be used for at least part of the joint portion.

When forming the compression portion and/or the joint portion by 3D printing, or when forming the entire midsole by 3D printing, the support layer and/or the outsole may be 3D printed together with the midsole (or the 3D printed portion thereof). In other words, the compression portion and/or the joint portion, or the midsole as such, may be formed monolithically and/or integrally with one or both of the support layer and the outsole by 3D printing.

The midsole may further comprise a connecting portion positioned between the joint portion and the compression portion, wherein the connecting portion has a third hardness which is less than the first hardness of the compression portion.

The compression portion and the connecting portion may be injection molded, 3D printed, and/or milled. They may be formed from a single midsole material. For example, the connecting portion may be formed as a 3D printed, three-dimensional network with a lower material density (e.g., by forming a more open network) and/or a softer configuration of the material being used in the connecting portion than in the compression portion.

The joint portion may be injection molded, 3D printed, and/or milled. The joint portion, the compression portion and the connecting portion may be formed from a single midsole material. For example, the joint portion may be formed as a 3D printed, three-dimensional network with a higher material density (e.g., by forming a more dense network) and/or a harder configuration of the material than the network formed in the compression portion and the connecting portion.

The compression portion may comprise two or more spaced apart segments, optionally wherein the spaced apart segments are separated by a void or by the connecting portion. The two or more spaced apart segments of the compression portion may be positioned along the medial side or the lateral side of the midsole. The two or more spaced apart segments of the compression portion may each comprise a different hardness each of which is less than the second hardness of the joint portion.

The joint portion and/or the compression portion may be configured to be modified or exchangeable for adapting the pivoting angle upon application of the locomotion force. Optionally, a plurality of separate segments forming the joint portion and the compression portion are configured to be individually modified or exchangeable.

Optionally, the sole comprises a forefoot area, a midfoot area, and a heel area, wherein the compression portion comprises a first segment in the forefoot area and a second segment in the heel area, optionally wherein the compression portion further comprises a third segment in the midfoot arca. Optionally, the compression portion extends along at least 20%, optionally at least 40%, optionally at least 60% of the side of the midsole.

The insole may further comprise a cushioning layer that is provided on the top surface of the support layer; and/or wherein an inlay is provided above the insole.

The support layer may comprise two or more rigid plates, wherein the two or more rigid plates are connected via an articulation.

An articulation, if present, may be constructed from fabric, rubber, plastic, cellulose, carbon fiber, metal, ceramic, and/or a type of elastomer.

The compression portion may comprise a foam material, and/or spring material, and/or a resilient polymer network, and/or a 3D printed mesh, and/or a damping material, such as a gel or an air cushion.

The joint portion may be positioned within 3 cm from the edge of the midsole, optionally within 2 cm, optionally within 1 cm.

A further aspect of the invention relates to an orthopedic shoe insert. The shoe insert comprises an insole comprising a support layer for supporting the foot of a user and a midsole positioned adjacent to the support layer. The midsole comprises a compression portion having a first hardness and a joint portion having a second hardness greater than the first hardness and being positioned on one of the medial side and the lateral side of the lower surface of the support layer, the joint portion being configured to allow the support layer to pivot about the joint portion when subjected to a locomotion force such that the compression portion is compressed. The joint portion defines a pivot axis extending along the lateral or medial side of the midsole and the support layer pivots about the pivot axis. The pivot axis is positioned within 3 cm, optionally 2 cm, optionally 1 cm of the edge of the midsole.

A further aspect of the invention relates to a method for adjusting the article or adjusting the orthopedic shoe insert as previously described. The method includes the step of evaluating the locomotion, optionally the gait, of a person. The person in this instance may have knee osteoarthritis. The method further comprises the step of positioning the joint portion and compression portion within the midsole and adjusting the hardness of the compression portion so as to modify the biomechanics of the knee during locomotion.

The present summary is provided only by way of example and not limitation. Other aspects of the present invention will be appreciated in view of the entirety of the present disclosure, including the entire text, claims, and accompanying figures.

### BRIEF DESCRIPTION OF THE DRAWINGS

The subject matter of the invention will be explained in more detail in the following text with reference to exemplary and non-limiting embodiments which are illustrated in the attached drawings. These figures disclose embodiments of the invention for illustrational purposes only. In particular, the disclosure provided by the figures and description is not meant to limit the scope of protection conferred by the invention.

FIG. 1 schematically depicts several embodiments of the midsole according to the invention;

FIG. 2 schematically depicts several embodiments of the support layer according to the invention;

FIG. 3 illustrates an embodiment of the article of orthopedic footwear shown in a side view cross-section along the line A-A of FIG. 4 and 5;

FIG. 4 illustrates a top view of the embodiment of FIG. 3 in cross-section through the midsole along the line B-B of FIGS. 3 and 5;

FIG. 5 illustrates a rear view of the embodiment of FIGS. 3 and 4 in cross-section through the heel area of the article along the line C-C in FIGS. 3 and 4;

FIG. 6 schematically depicts several exploded embodiments of the invention;

FIG. 7 schematically depicts several exploded embodiments of the invention;

FIG. 8 schematically depicts several embodiments of the midsole according to the invention;

FIG. 9a illustrates a cross-section view of one embodiment of the midsole along the line B-B of FIG. 9b;

FIG. 9b illustrates a cross-section through the midsole along the line A-A of FIG. 9a;

FIG. 9c illustrates a cross-section view of one embodiment of the midsole along the line D-D of FIG. 9d;

FIG. 9d illustrates a cross-section through the midsole along the line C-C of FIG. 9c;

FIG. 10 illustrates an embodiment of the article of orthopedic footwear shown in a side view cross-section along the line A-A of FIGS. 11 and 12;

FIG. 11 illustrates a top view of the embodiment of FIG. 3 in cross-section through the midsole along the line B-B of FIGS. 10 and 12; and

FIG. 12 illustrates a rear view of the embodiment of FIGS. 10 and 11 in cross-section through the heel area of the article along the line C-C in FIGS. 10 and 11.

### DETAILED DESCRIPTION

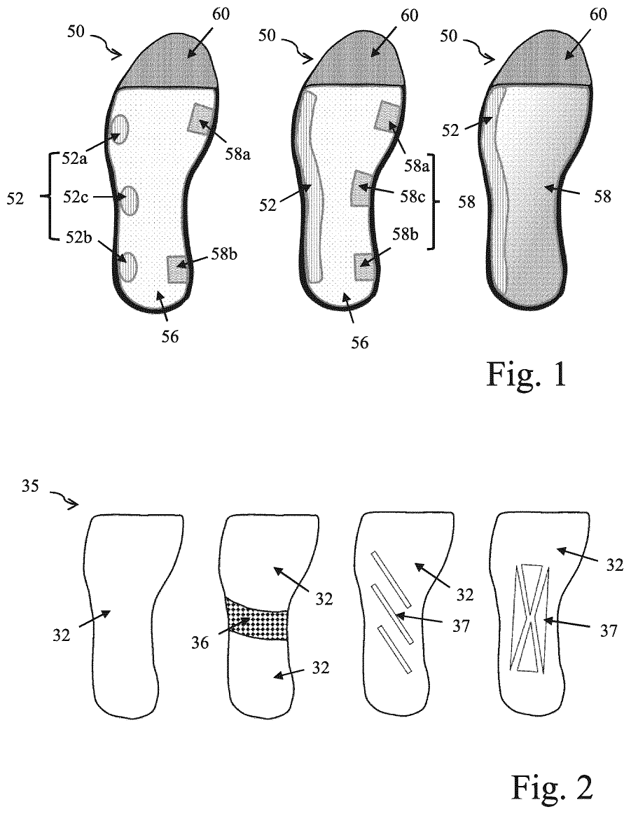

In FIG. 1 an embodiment of the article 10 of orthopedic footwear is depicted. The view presented in FIG. 1 is a top-down view of a cross-section through the midsole 50 of the article of footwear 10. The midsole 50 comprises a joint portion 52 which is positioned below and/or potentially attached to a support layer 35 of the insole 30 (as shown in FIG. 2) which creates a pivot axis about which the support layer 35 can pivot. The joint portion 52 is positioned along one of the medial side or the lateral side of the lower surface of the support layer 35.

The midsole 50 further comprises a compression portion 58 which is characterized by a first hardness configured to allow the compression portion 58 to compress when the support layer 35 pivots about the joint portion 52. The compression portion 58 may comprise a foam material, a spring material, a resilient polymer network, a 3D printed mesh, and/or a damping material, such as gel or air cushion. In some embodiments the compression portion can extend along at least 20%, optionally at least 40%, optionally at least 60% of the side of the midsole. By adjusting the compressibility, i.e. hardness, of the compression portion 58 (wherein different segments 58a, 58b, 58c of the compression portion 58 may be provided with different stiffnesses) the pivoting of the support layer 35 about the joint portion 52, and thus the pivoting behavior during one or more gait phases or during other types of locomotion, can be adjusted in accordance with the requirements identified for the respective wearer.

Generally, the support layer 35 can be enabled to pivot about both a medial-lateral and anterior-posterior axis simultaneously. For example, a joint portion 52 may connect at only one location to the support layer 35. The support layer 35 may pivot about any appropriate axis so as to arrive at an improved ambulatory biomechanics for the wearer.

The exact locations of the joint portion 52 and the compression portion 58 within the midsole 50 is highly dependent on the desired changes in locomotion biomechanics that could be person specific, such as, for example, the gait pattern or the presentation of knee OA within the wearer. However, the joint portion 52 is optionally located along either the medial side or the lateral side of the midsole 50 as a joint located closer to the midline of the shoe may limit the possibility to achieve the desired biomechanical changes. For example, it has been found that when a joint is positioned too far from the edges of the midsole 50, the wearer may be able to walk along, or balance, on top of the joint. Such a configuration is undesirable as this prevents the desired adjustment of gait by pivoting. Therefore, it is optional to have the joint portion 52 positioned and/or attached to the support layer 35 within 3 cm, optionally within 2 cm, optionally within 1 cm from the edge of the midsole 50.

As previously mentioned, knee OA is often related to the ambulatory loading of the knee joint. One particularly advantageous example of the present invention, as shown in FIG. 1, can be used to address knee joint OA, particularly if the disease has begun to disproportionately affect the medial compartment of the knee joint. In such a configuration of the invention the joint portion 52 would be positioned along the lateral side of the midsole 50 and may be attached to the support layer 35 only on the lateral side. The joint portion 52 may comprise two or more joint segments. As shown in the example in FIG. 1 on the left side, the joint portion 52 comprises a first segment 52a positioned in the forefoot area of the midsole 50, a second segment 52b of the joint portion 52 is positioned in the heel area of the midsole 50 and a third segment 52c is positioned in the midfoot area of the midsole 50. This allows the support layer 35 to pivot predominantly in the medio-lateral direction. Such an adjustment is believed to help in reducing symptoms, slowing down the deterioration of the joint and preserving knee joint function for longer than an unaddressed gait would allow.

Importantly, the above configuration is one example of a common presentation of knee OA, namely, knee OA predominantly in the medial compartment of the joint. There exist other common presentations of knee OA and many other conditions where the invention could be used, upon proper configuration of the joint and compression portions. For example, with knee OA predominantly affecting the lateral compartment of the knee joint, the invention could be configured with the joint portion 52 along the medial side of the midsole 50. During the gait of the patient the weight or loading of the midsole 50 will pivot the support layer 35 to the lateral side, thus changing the mechanics at the knee joint, including unloading the lateral compartment. Further configurations are also envisioned which include changing the ambulatory biomechanics of a wearer by further pivoting the support layer 35 either posteriorly or anteriorly or about any appropriate axis so as to arrive at an improved ambulatory biomechanics for the wearer. It will be appreciated from the present disclosure that this can be achieved by placing the joint and compression portions accordingly.

In the example shown in the left side of FIG. 1, the compression portion 58 is located along the medial side of the midsole 50 and comprises two segments 58a, 58b which are spaced apart and located in the forefoot area of the midsole 50 and the heel area of the midsole 50, respectively. However, this placement of the compression portion 58 is merely one many useful alternatives. The compression portion 58 for this embodiment may instead comprise additional segments such as shown in the example depicted in the middle of FIG. 1 or may comprise a single segment with spatially varying compressibility extending along a large portion of the side of the midsole 50 as shown, for example, on the right side of FIG. 1. In some embodiments the compression portion 58 may also be located closer to the joint portion 52, for example along the midline of the foot depending on the compressibility of the compression portion. For certain embodiments the compression portion may have a hardness between 10 Shore A and 90 Shore A, optionally between 20 Shore A and 85 Shore A, optionally between 30 Shore A and 80 Shore A.

Certain types of gait issues may also benefit from a pivoting of the support layer in the anterior-posterior direction as well as in the medio-lateral direction. Joint selection and positioning can enable the support layer to pivot in both of these directions simultaneously about the joint portion.

It is envisioned that in addition to pre-designed footwear articles 10 which address common conditions such as knee OA, the present invention encompasses a footwear article 10 which can be designed and constructed based on the individual needs of a wearer. The individual needs may be characterized based on movement measures, for example, the joint angles, moments or forces or the plantar pressure distributions or the muscle activations of the wearer during walking or during other activities, structural or compositional measures of the knee joint using medical imaging or any other measures allowing the definition of the desired ambulatory biomechanical change for the wearer. Based upon these individual measures, a footwear article 10 according to the present invention could be constructed to achieve the desired individual biomechanical change during walking and/or running and/or any locomotion activities.

The compression portion 58 may be configured to be modified or exchanged, such that the footwear article 10 can be adapted to meet the needs of the wearer. Moreover, the compression portion 58 may include a plurality of segments 58a, 58b, 58c, each of which may be configured to be individually modified or exchanged. For example, one or more compression portion segments 58a, 58b, 58c may be loosely disposed in the midsole, so that they can be replaced when desired by a harder or softer segment. For example, foams of different stiffness or 3D printed segments of varying structures may be used for this purpose.

The joint portion 52 may include one, two, three or more separate segments which individually contribute to the pivoting behavior of the support layer 35. In one example shown in the left side of FIG. 1, the midsole 50 comprises a joint portion 52 having three segments 52a, 52b, and 52c. In such a configuration the support layer 35 is configured to pivot predominantly medio-laterally.

The joint portion 52 may comprise one or more of a ball joint, an accordion joint, a saddle joint, an elastic joint, a condyloid joint, a bellows joint, and/or a hinge joint. As, for example in the left-side example of FIG. 1, each of the segments 52a, 52b, and 52c may be one of these types of joints.

In other embodiments the joint portion 52 may comprise one or more elastic joints, made from bendable, resilient material.

In an embodiment depicted on the right side of FIG. 1, the joint portion 52 may comprise a material having a greater hardness than that of the rest of the midsole 50. In particular, the joint portion 52 may have a hardness greater than that of the compression portion 58. The joint portion 52 may have a hardness of at least 80 Shore A, optionally at least 90 Shore A, optionally at least 100 Shore A. Additionally, the joint portion 52 can extend along at least 20%, optionally at least 40%, optionally at least 60% of the side of the midsole 50. Such a configuration allows the joint portion 52 to be essentially incompressible when the normal weight of a wearer is applied. When a locomotion force is applied to the insole 30 during walking, running or any locomotion activities the joint portion 52 remains firm while the compression portion 58 is compressed. The reduction in height of the side of the midsole 50 due to compression of the compression portion 58 allows the support layer 35 to pivot according to the present invention.

In advantageous embodiments, the majority of the midsole 50 or its entirety is created using 3D printing methods. The 3D printed material of the midsole 50 may comprise PLA, TPE, TPU, Nylon, etc. Said 3D printed materials may be printed in a network or cellular construction. Based on the density, printing pattern, or the type of materials used, different parts of the midsole 50 may be constructed to have different hardnesses and/or stiffnesses. For example, a medial side of the midsole 50 may be printed with a very high density of material corresponding to the joint portion 52 of the present invention. The compression portion 58 may be printed with a lower density, and thus result in a softer, more flexible structure.

FIG. 2 illustrates a few examples of suitable support layers 35 for use within the article 10 of orthopedic footwear. The support layer 35 may comprise at least one rigid plate 32. In some cases the entire support layer 35 may be a rigid plate 32. In some embodiments the rigid plate 32 may underly the entirety of the foot of the wearer, or the majority of the foot of the wearer up until the toe portion of the insole 30. In other words, the support layer 35 may extend along at least the heel and midfoot areas of the sole, or at least along the midfoot and forefoot areas of the sole. Optionally, the support layer 35 extends along the heel, midfoot and forefoot areas of the sole.

The support layer 35 may comprise a forefoot area and a midfoot area, optionally also a toe area and/or a heel area.

The support layer 35 may comprise one or more rigid plates 32 possibly having cutouts 37, holes, or points of articulation 36. The rigid plates 32 within the support layer 35 are intended to be load bearing without undergoing deformation. However, during locomotion of the wearer the insole 30 may need to bend or articulate in order to accommodate the roll of the foot. Providing an articulation, for example, between two rigid plates 32 can allow a more natural function of the foot during walking while maintaining a hard and/or inflexible surface from which the support layer 35 may pivot about the joint portion 52. In some configurations the support layer 35 may comprise two, three or more rigid plates 32, which are connected via one or more articulations 36.

As the support layer 35 provides the lever arm which pivots about the joint portion 52, it is advantageous to provide a support layer 35 which has a higher rigidity and/or stiffness than the midsole 50. Alternatively or additionally, the support layer 35 may have a higher rigidity and/or stiffness than the outsole 20. Alternatively or additionally, in some configurations the support layer 35 may be at least as rigid and/or stiff as the joint portion 52. In some implementations, all rigid plates 32 when subjected to a pressure of 10 N per square centimeter may be configured to deform less than 8 mm, optionally less than 5 mm, and optionally less than 3 mm. In this way, the deformation of the support layer 35 due to the flexibility of the rigid plate 32 would have minimum effect on the pivoting of the support layer 35.

For example, when clamped on the medial side and on the lateral side along a clamping length of at least 5 cm, optionally along the forefoot area and/or along the midfoot area and/or along the heel arca, and subjected to a test force of 10 N/cm² using a 10 mm diameter ball indenter, the rigid plate 32, optionally does not deform more than 8 mm, optionally not more than 5 mm, optionally not more than 3 mm in the direction of the test force. Optionally, the test force is applied between the clamps and centrally between the medial side and the lateral side.

The rigid plate 32 may be constructed of metal, plastic, cellulose, acetal, acrylic, high-density polyethylene, polycarbonate, carbon fiber, and/or ceramic. An articulation, if present, may be constructed from fabric, rubber, plastic, cellulose, carbon fiber, metal, ceramic, and/or a type of elastomer.

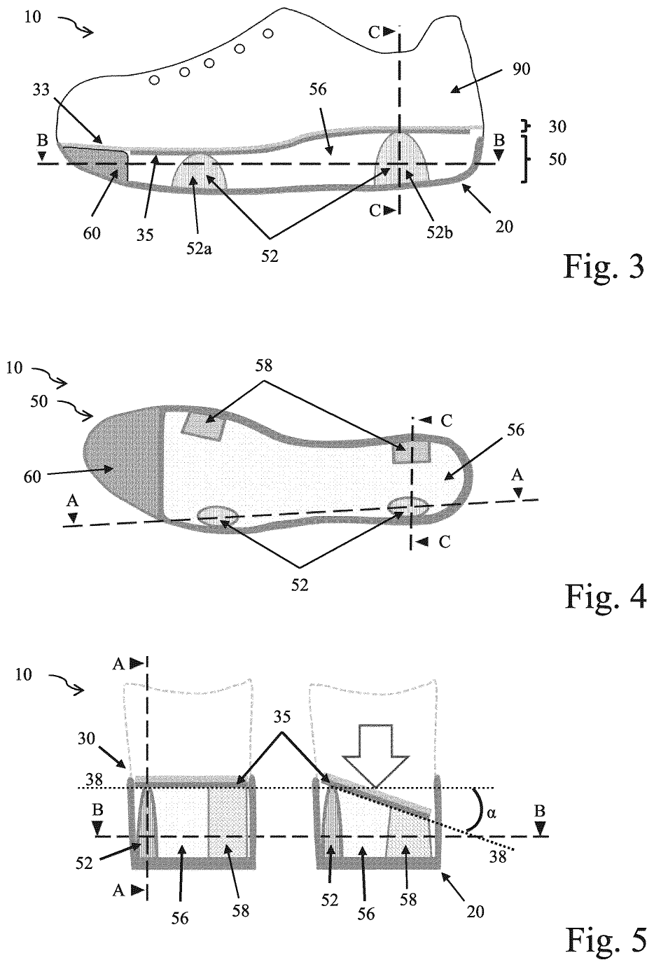

Although the support layer 35 is depicted within some of the present figures to be planar, the support layer 35 may also be configured to take on a three-dimensional shape appropriate for the support of a foot, as in the example in FIG. 3. The support layer 35 may be configured to provide arch support for the wearer. This support layer 35 may in some cases be custom formed to the foot of the wearer in order to provide individualized support.

FIGS. 3-5 present different views of one embodiment of the article 10 of orthopedic footwear. FIG. 3 represents a cross-section of the article 10 taken along line A-A (as shown in FIGS. 4 and 5). FIG. 4 represents a cross-section of the article 10 taken along line B-B (as shown in FIGS. 3 and 5). FIG. 5 represents a cross-section of the article 10 taken along line C-C (as shown in FIGS. 3 and 4).

FIG. 3 presents a side view of the article 10 which comprises an outsole 20, an insole 30, and a midsole 50. In this configuration the midsole 50 comprises a joint portion 52 having two segments, a first segment 52a being positioned in the forefoot area of the midsole 50 and a second segment 52b in the heel area of the midsole 50. That is, the support layer 35 of the insole 30 is positioned above and potentially attached to the joint portion 52 at a first segment 52a and at the second segment 52b.

As shown in FIG. 3 the article 10 of orthopedic footwear may have an upper 90. The upper 90 may be configured for a sport shoe, a walking shoe, a general-purpose shoe, a sandal, a slipper, etc. It is optional that the upper 90 be attached to the sole at the midsole 50 or the outsole 20. Optionally, the upper 90 is not attached directly to the insole 30. This allows the support layer 35 to pivot and the midsole 50 to deform within the footwear article 10.

The support layer 35 of the insole 30 as shown in FIG. 3 may comprise at least one rigid plate 32. The insole 30 may further comprise a cushioning layer 33 provided on top of the support layer 35. Optionally, an inlay may be provided above the insole 30 to increase comfort of the wearer.

As shown in FIG. 4, the midsole 50 may also comprise a connecting portion 56 which fills the midsole 50 in between the joint portion 52 and the compression portion 58. Alternatively, the connecting portion 56 may extend throughout the entire midsole and at least partially around the joint portion 52 and the compression portion 58. A further alternative of the article 10 comprises a midsole which is empty except for the joint portion 52 and the compression portion 58. Generally, a connecting portion 56 will have a hardness which is less than that of both the compression portion 58 and the joint portion 52. In some embodiments the joint portion 52, connecting portion 56 and compression portion 58 may be formed from a single midsole material, which can, for example be constructed using 3D printing.

The connecting portion 56 may be a foam, a gel, a damping material, an air cushion, a 3D printed network, and/or a resilient polymer network.

In some embodiments the toe portion of the midsole may further comprise a filler material 60 which could act as a cushion for the toe portion of the foot. The filler material may be a foam, a gel, an air cushion, a resilient polymer network, and/or a 3D printed network.

FIG. 5 illustrates a cross section through the second segment of the joint portion 52. This cross section illustrates the support layer 35, which defines a virtual support plane 38. When the support layer is not subjected to a locomotion force, the support plane 38 assumes a neutral position indicated by the dotted line. The joint portion 52 in combination with the compression portion 58 allows the support layer 35 to pivot when subjected to a locomotion force. The support layer 35, as defined by the support plane 38 pivots under the locomotion force by a pivoting angle α. It is advantageous to provide a pivoting angle of at least 1°, optionally at least 3°, optionally at least 5° from the neutral position. Alternatively, the pivoting angle may be within the range of 1° to 20°, optionally within the range of 3° to 15°, and optionally within the range of 5° to 12°,

Although the pivoting angle as presented in FIG. 5 is shown around an anterior-posterior axis, the pivoting angle may occur around a medio-lateral axis or around any axis therebetween.

As can also be seen in FIG. 5, the joint portion 52 defines a pivot axis at the junction between the joint portion 52 and the support plane 38 about which the support plane 38 can pivot. This pivot axis is advantageously positioned within 3 cm of the edge of the insole 30 or midsole 50, optionally within 2 cm, optionally within 1 cm, optionally wherein the pivot axis extends along the lateral side or the medial side. Generally, the support plane 38 extends through the pivot axis. However, in some configurations where the pivot axis is not at the junction between the joint portion 52 and the support plane 38, such as when the support layer 35 has a 3D structure to support the foot, the support plane 38 may be defined as a virtual plane tangent to the lower surface of the support layer 35. In many cases, the neutral position of the support plane 38 is parallel with respect to the ground. Correspondingly, the pivoting angle may be defined relative to the ground as well.

The locomotion force, as illustrated by the downward pointing arrow in FIG. 5 is a force when exerted upon the insole 30 and/or support layer 35 causes the support layer 35 to pivot within the ranges described above. The locomotion force is advantageously measured during locomotion, such as during walking. The force imparted upon the insole 30 of the footwear article 10 during walking, for example, necessarily varies by the timepoint of the gait cycle. The highest magnitude forces during the gait cycle are rarely imparted strictly vertically and are often directed to only certain portions of the insole 30. Thus, when considering a locomotion force causing the support layer to pivot during locomotion, only the component of the force perpendicular to the support layer 35 (or the virtual plane defined by the support layer 35) should be considered. In some cases this means that only the component of the force normal to the ground will be considered. The locomotion force may be applied to at least one of a forefoot area, a midfoot area, or a heel area of the support layer 35. In some instances, the locomotion force may also be applied to the toe portion of the insole 30. The locomotion force may roughly correspond to the forces generated by a person walking, jogging or running, i.e. between 0.6 and 5.0 times the bodyweight of the wearer. Alternatively, the locomotion force may be between 400 N and 6000 N, optionally between 500 N and 5000 N.

For comfort and stability of the wearer, it may be advantageous to provide an article 10 of orthopedic footwear which achieves the desired pivoting angle as described above only during locomotion, i.e. walking, jogging or running but not during standing. When the wearer stands, it is optional that the support layer 35 pivots to a lesser degree, such as at most 10°, optionally at most 5°, optionally at most 3°, optionally the support plane 38 remains in a neutral position. Thus, it can also be defined that when a standing force of between 0.4 and 0.6 times the bodyweight of the wearer is applied to the support layer 35 in a direction normal to the ground, that the pivoting angle is lesser or equal to the pivoting angle achieved during walking, jogging or running. Alternatively, the standing force may be between 150 N and 700 N, optionally between 200 N and 500 N.

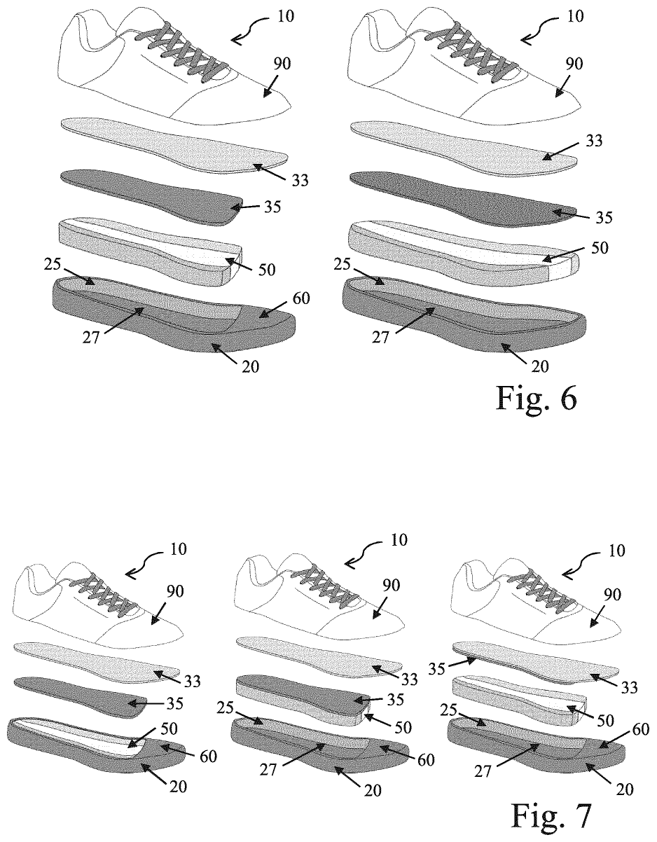

FIG. 6 illustrates two different configurations of the present invention. In the examples provided, each of the layers of the article 10 of orthopedic footwear is depicted individually. The outsole 20 is provided as the base of the article 10, the midsole 50 is supported on top of the outsole 20, the support layer 35 is positioned above the midsole 50, the cushioning layer 33 is provided atop the support layer 35, and the upper 90 is positioned above the cushioning layer 33. As with other embodiments, the support layer 35 and the cushioning layer 33 together form the insole. Notably, in the example provided on the left side of FIG. 6, the outsole 20 further comprises filler 60 within the toe portion. The outsole 20 also further comprises a lip 25 extending upward from the outer edge of the outsole 20. The lip 25 may partially or fully outline a recess 27 into which the midsole 50 may be positioned. The lip 25 may also include filler 60 within the toe portion of the article 10. The recess 27 defined by the lip 25 may be sized and shaped to receive the midsole 50 such that the midsole 50 is fixed in position.

In other words, the outsole 20 may provide a recess 27 configured for receiving the midsole 50. The recess 27 may be delimited by a circumferential wall or lip 25, which may extend at least partially or entirely around the recess 27. The toe portion may be formed as part of the outsole 20 (FIG. 6 left) or as part of the midsole 50 (FIG. 6 right).

On the left side of FIG. 6, the midsole 50 and the support layer 35 are provided from the heel to the metatarsal heads, and the toe portion is made of a filler 60.

On the right side of FIG. 6, the midsole 50 and the support layer 35 are provided within the full-length of the foot. Other lengths of the midsole 50 and/or the support layer 35 are possible, and they may be made by two or more elements.

FIG. 7 illustrates three different configurations of the present invention in the case of the midsole 50 and the support layer 35 are provided from the heel to the metatarsal heads. The configurations depicted in FIG. 7 are also possible with full-length midsole 50 and/or support layer 35.

On the left side of FIG. 7, the outsole 20 and the midsole 50 are provided together as a unit. The outsole 20 and the midsole 50 may be bonded together after fabrication or they may be integrally formed, e.g. by 3D printing.

In the center example provided in FIG. 7, the midsole 50 and the support layer 35 are provided together as a unit. The midsole 50 and the support layer 35 may be bonded together after fabrication or they may be integrally formed, e.g. by 3D printing.

On the right side of FIG. 7 a further example of the article 10 is provided, wherein the cushioning layer 33 and the support layer 35 are provided together as a unit. The cushioning layer 33 and the support layer 35 may be bonded together after fabrication or they maybe integrally formed, e.g. by 3D printing.

In any of the examples presented in FIG. 7, the midsole 50, the support layer 35, the cushioning layer 33 and the upper 90 may have any configuration as discussed herein, and may be provided as separated elements or together as a unit. In particular, the upper 90 may be attached to any one of the insole 30, the midsole 50, or the outsole 20. It is envisioned that the midsole 50, the combination midsole 50/support layer 35, or the combination of the midsole 50, the support layer 35, and the cushioning layer 33 may be sold or provided as a separate shoe insert. In this case, a person owning the article 10 may be prescribed or may otherwise purchase a new midsole 50 insert which can then be exchanged with a previous midsole 50. Moreover, this may allow a manufacturer of the article 10 to sell an article 10 suitable for a plurality of users, into which each user may then insert his/her personalized midsole 50.

In particular, a wearer may visit a doctor or other skilled specialist who can assess the standing and gait patterns of the wearer. Using knowledge of the wearers particular needs with knee osteoarthritis, the skilled specialist can adjust the midsole, by determining the location of the joint portion 52 and the compression portion 58, by adjusting the stiffness of the compression portion 58, and by determining how their cooperation results in a corrective pivoting motion of the support layer 35. In this way new footwear articles 10 or midsoles 50 can be provided to the wearer to partially ameliorate knee osteoarthritis.

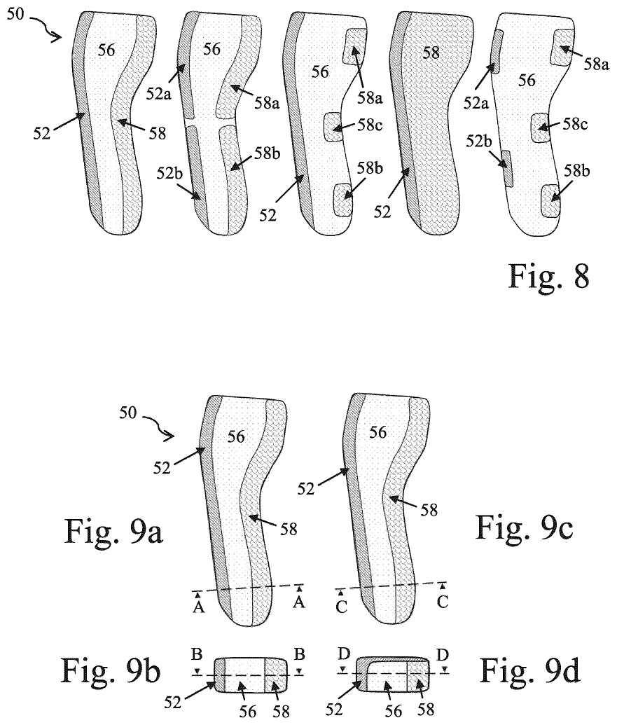

FIG. 8 illustrates a number of different configurations of the midsole 50. These embodiments focus on the formation of a midsole using 3D printing techniques. Each of the examples presented in FIG. 8 may be created using a 3D printing technique in a single fabrication step in which each region of the midsole, including the joint portion 52, the compression portion 58, and (if present) the connecting portion 56 are fabricated during 3D printing using different configurations of the 3D printed network. This may be achieved using different network orientations, patterns, densities and/or pore sizes. As such, the stiffness and/or compressibility of each portion can be varied during the 3D printing process. Alternatively, each of the joint portion 52, the compression portion 58, and (if present) the connecting portion 56 may be fabricated separately and subsequently joined together to form the midsole 50. 3D printing techniques in the sense of the present invention includes, but does not limit to stereolithography, selective laser sintering, fused deposition modeling, digital light process, electron beam melting, selective laser melting, binder jetting, material jetting, laminated object manufacturing, multi jet fusion, and/or direct metal laser sintering. 3D printing materials includes, but is not limited to polymers, such as polylactic acid, acrylonitrile butadiene styrene, polyurethane, polyamide, nylon, polystyrene, and/or polypropylene, resins, metals, epoxy-based materials, and/or carbon fiber.

Starting from the left, the first example provided in FIG. 8 represents a 3D printed midsole 50 wherein the entire lateral side of the midsole 50 comprises the joint portion 52 (e.g., along the entire lateral edge or boundary of the midsole 50). As previously discussed, the joint portion 52 in the configuration may have a greater hardness (i.e. less compressibility) than either of the compression portion 58 or the connecting portion 56. In this configuration the entire medial side of the midsole 50 comprises the compression portion 58, wherein the compression portion 58 has greater compressibility (i.e. less hardness) than the joint portion 52 and/or the connecting portion 56. The connecting portion 56 forms the part of the midsole 50 which is neither the joint portion 52 nor the compression portion 58.

In the second example of FIG. 8 from the left, the joint portion 52 forms greater than 90% of the lateral side of the midsole 50. The joint portion 52 may comprise a first segment 52a and a second segment 52b, with each segment being positioned on or near the lateral edge or boundary of the midsole 50. Additionally, the compression portion 58 may comprise a first segment 58a and a second segment 58b, wherein the compression portion 58 forms greater than 90% of the medial side of the midsole 50. The segments 58a and 58b may have a different hardness from each other. It will be understood that the joint portion 52 shown in FIG. 8 may be combined with any of the compression portions 58 shown throughout the various examples of FIG. 8. Conversely, it will be understood that the compression portion 58 formed by two segments, e.g. the two segments 58a, 58b, may be combined with any of the joint portions shown in the various examples of FIG. 8.

In the third example of FIG. 8 from the left, the joint portion 52 comprises a single segment positioned on the lateral side of the midsole 50, and the compression portion 58 may comprise a plurality of different segments 58a, 58b, 58c positioned along the medial side of the midsole 50 and possibly having different hardnesses. It will be understood that the compression portion 58 formed by a plurality of different segments, e.g. three different segments 58a, 58b, 58c or more, may be combined with any of the joint portions shown in the various examples of FIG. 8.

In the fourth example provided in FIG. 8 from the left, the joint portion 52 is positioned on the lateral side of the midsole 50. The rest of the midsole 50 is formed by the compression portion 58. The compression portion 58 in such a configuration may have a single, uniform hardness or may provide a gradient of hardness in the medial/lateral direction. Again, it will be understood that such compression portion 58 may be combined with any of the various joint portions 52 shown in FIG. 8.

In the fifth and rightmost example provided in FIG. 8 the joint portion 52 comprises a first segment 52a and a second segment 52b, each positioned on the lateral side of the midsole 50. One joint portion 52a is positioned in the forefoot area and the second joint portion 52b is positioned in the midfoot or heel area. The compression portion 58 comprises a plurality of segments 58a, 58b, 58c positioned in the forefoot area, midfoot area, and heel area, respectively, and having possibly different hardnesses. The connection portion 56 forms the remaining area of the midsole 50. Again, it will be understood that such joint portion 52 may be combined with any of the various compression portions 58 shown in FIG. 8.

FIGS. 9a-9d illustrate further configurations of the midsole 50 that may be provided using 3D printing. In FIGS. 9a and 9b, the width of each of the joint portion 52, the connection portion 56, and the compression portion 58 in the superior-inferior axis. Conversely, in FIGS. 9c and 9d, the width of the joint portion 52 changes along the superior-inferior axis. In this example the superior part of the joint portion 52 is extending to the full width of the midsole 50, acting as the support layer 35.

In each of the examples presented above the lateral/medial positioning of the joint portion 52 and the compression portion 58 may be switched. The lateral/medial positioning of the joint portion 52 and the compression portion 58 may depend on the specific orthopedic needs of the user.

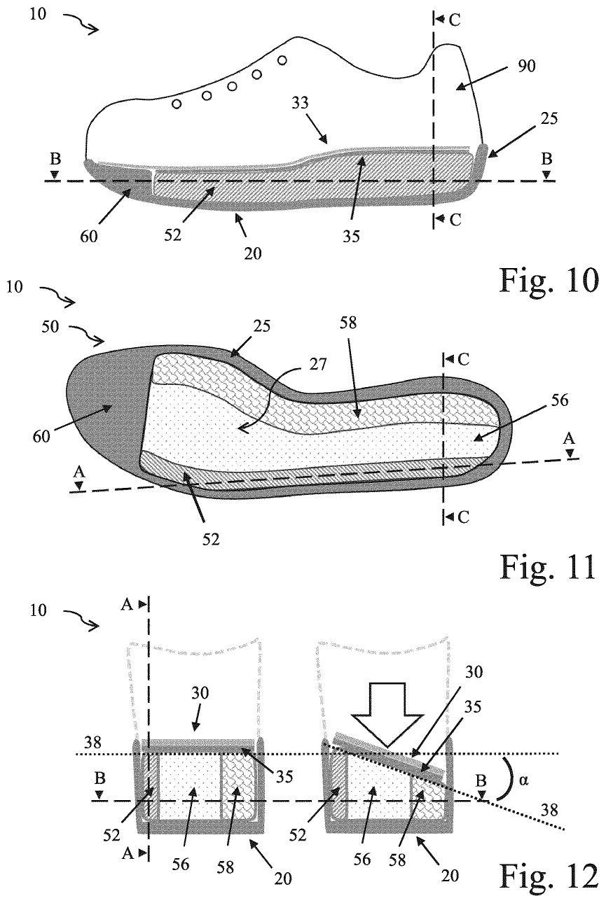

FIGS. 10-12 provide different views of one embodiment of the present invention. The midsole 50 of this article 10 is formed using 3D printing techniques. As in FIG. 6, the outsole 20 comprises a lip or circumferential wall 25 which extends upward and creates a recess 27 into which the midsole 50 may be introduced. The toe area of this article may comprise filler material 60 which acts as a cushion for the toe portion of the foot. On the upper surface of the midsole 50 a support layer 35 is provided according to any of the embodiments described herein. On the supper surface of the support layer 35 a cushioning layer may be provided. In this embodiment the upper 90 may attach directly to the lip or circumferential wall 25 of the outsole 20.

The left side of FIG. 12 illustrates the midsole 50 within the article 50 when no pressure is applied to the insole, i.e. when no weight is applied to the midsole 50. On the right side of FIG. 12 the weight of the user is applied to the insole which transmits this compression force to the midsole 50. As can be observed, the joint portion 52 is non-compressible, or at least less compressible than the other portions of the midsole 50. The compression portion 58 is compressed due to the weight of the user and the connection portion 56 is also partially compressed due to the weight of the user. Due to the difference in hardness of each of the midsole 50 portions, the support layer 35 tilts, forming and angle α relative to the unloaded position, as illustrated. The angle α may be defined by the orientation of the virtual support plane 38, as previously discussed.

While the invention has been illustrated and described in detail in the drawings and foregoing description, such illustration and description are to be considered illustrative or exemplary and non-restrictive; the invention is thus not limited to the disclosed embodiments. Variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality and may mean “at least one”.

For example, while the invention has been described with reference to knee osteoarthritis the articles of orthopedic footwear disclosed therein could be used to treat other musculoskeletal pathologies of the spine, hip, knee, ankle, and/or foot.

The following are optional aspects of the invention:

1. An article of orthopedic footwear having a sole, the sole comprising:
an outsole which forms at least a portion of the ground-contacting surface of the footwear article;
an insole comprising a support layer for supporting the foot of a user, the support layer optionally comprising a rigid plate and having a lower surface; and
a midsole positioned between and/or separating the support layer from the outsole and comprising
   a compression portion having a first hardness and being positioned below the lower surface of the support layer; and
   a joint portion being positioned below one of the medial side and the lateral side of the lower surface of the support layer, the joint portion being configured to allow the support layer to pivot about the joint portion when subjected to a locomotion force such that the compression portion is compressed.

2. The article of aspect 1, wherein the joint portion has a second hardness greater than the first hardness.

3. The article of aspect 1 or 2, wherein the joint portion has a hardness of at least 80 Shore A, optionally at least 90 Shore A, optionally at least 100 Shore A.

4. The article of aspect 1 or aspect 2, wherein the joint portion is configured to be essentially incompressible, and/or positioned below and/or attached to the lower surface of the support layer.

5. The article of any one of the previous aspects, wherein the joint portion is positioned such that the support layer is enabled to pivot in a medial-lateral direction, optionally wherein the support layer is enabled to pivot both in a medial-lateral direction and in an anterior-posterior direction.

6. The article of any one of the previous aspects,
wherein the support layer is more rigid and/or stiff than the midsole; and/or
wherein the support layer is more rigid and/or stiff than the outsole; and/or
wherein the support layer is at least as rigid and/or stiff as the joint portion.

7. The article of any one of the previous aspects, wherein the joint portion comprises one or more of a ball joint, an accordion joint, a saddle joint, an elastic joint, a condyloid joint, a bellows joint and/or a hinge joint.

8. The article of any one of the previous aspects, wherein the compression portion has a hardness between 10 Shore A and 90 Shore A, optionally between 20 Shore A and 85 Shore A, optionally between 30 Shore A and 80 Shore A.

9. The article of any one of the previous aspects, wherein the joint portion is more rigid and/or stiff than the compression portion.

10. The article of any one of the previous aspects, wherein the article further comprises an upper which is attached to the sole at the midsole or the outsole, optionally wherein the upper is not attached directly to the insole.

11. The article of any one of the previous aspects,
wherein the support layer defines a support plane;
wherein the support plane has a neutral position when the support layer is not subjected to a locomotion force;
wherein the article is configured such that, when the support layer is subjected to a locomotion force, the support plane pivots by a pivoting angle of at least 1°, optionally at least 3°, optionally at least 5° from the neutral position.

12. The article of aspect 11, wherein the neutral position is parallel to the ground, optionally wherein the support plane is tangent to the support layer.

13. The article of any one of the previous aspects, wherein the locomotion force is between 0.6 and 5.0 times the bodyweight of the wearer; or wherein the locomotion force is between 400 N and 6000 N, optionally between 500 N and 5000 N.

14. The article of any one of the previous aspects, wherein the locomotion force is applied to at least one of a forefoot area, a midfoot area, or a heel area of the support layer, optionally wherein the locomotion force is applied during a stride of a person.

15. The article of any one of aspects 11-14, wherein when a standing force is applied to the support layer during standing of a person, the standing force causes the support plane to pivot by a pivoting angle of at most 10°, optionally at most 5°, optionally at most 3°, optionally the support plane remains in a neutral position.

16. The article of any one of aspects 11-15, wherein the standing force is between 0.4 and 0.6 times the bodyweight of the wearer; alternatively, the standing force is between 150 N and 700 N, optionally between 200 N and 500 N.

17. The article of any one of aspects 11-16, wherein the joint portion defines a pivot axis, and wherein the support plane pivots by the pivoting angle about the pivot axis.

18. The article of any one of aspect 17, wherein the pivot axis is positioned within 3 cm of an edge of the insole, optionally within 2 cm of the edge of the insole, optionally within 1 cm of the edge of the insole, optionally wherein the pivot axis extends along the lateral side or the medial side.

19. The article of any one of aspects 11 to 18,
wherein the support plane extends through the pivot axis; and/or
wherein the support plane is tangent and/or parallel to the lower surface of the support layer.

20. The article of any one of aspects 11 to 19,
wherein the support plane in the neutral position is parallel to the ground; and
wherein the support plane forms the pivoting angle with respect to the ground.

21. The article of any one of aspects 11 to 20, wherein, when the support layer is subjected to the locomotion force, the pivoting angle is within the range of 1° to 20°, optionally within the range of 3° to 15°, and optionally within the range of 5° to 12°.

22. The article of any one of the previous aspects, wherein the rigid plate of the support layer is configured to deform less than 8 mm, optionally 5 mm, optionally 3 mm when subjected to a pressure of 10 N per square centimeter.

23. The article of any one of the previous aspects, wherein the joint portion is formed from a different material than the support layer.

24. The article of any one of the previous aspects, wherein the support layer is injection molded, 3D printed, milled, made from fiber reinforced plastics, recycled material, cardboard, metal, plastic, cellulose, acetal, acrylic, high-density polyethylene, polycarbonate, carbon fiber, and/or ceramic.

25. The article of any one of the previous aspects, wherein the compression portion and the joint portion are formed from a single midsole material, optionally wherein the midsole is formed by 3D printing.

26. The article of any one of the previous aspects, wherein the midsole further comprises a connecting portion positioned between the joint portion and the compression portion, the connecting portion having a third hardness which is less than the first hardness.

27. The article of aspect 26, wherein the joint portion, the compression portion, and the connecting portion are formed from a single midsole material, optionally wherein the midsole is formed by 3D printing.

28. The article of any one of the previous aspects, wherein the compression portion comprises two or more spaced apart segments, optionally wherein the spaced apart segments are separated by a void or by the connecting portion.

29. The article of aspect 28, wherein the two or more spaced apart segments of the compression portion are positioned along the medial side or lateral side of the midsole.

30. The article of aspect 28 or aspect 29, wherein the two or more spaced apart segments of the compression portion each comprise a different hardness each of which is less than the second hardness of the joint portion.

31. The article of any one of the previous aspects, wherein the first hardness of the compression portion varies spatially.

32. The article of any one of aspects 28-31,
wherein the sole comprises a forefoot area, a midfoot area, and a heel area;
wherein the compression portion comprises a first segment in the forefoot area and a second segment in the heel area, optionally wherein the compression portion further comprises a third segment in the midfoot area.

33. The article of any one of the previous aspects, wherein the compression portion extends along at least 20%, optionally at least 40%, optionally at least 60% of the side of the midsole.

34. The article of any one of the previous aspects, wherein the joint portion and/or the compression portion are configured to be modified or exchangeable for adapting the pivoting angle upon application of the locomotion force, optionally wherein a plurality of separate segments forming the joint portion and the compression portion are configured to be individually modified or exchangeable.

35. The article of any one of the previous aspects,
wherein the sole comprises a forefoot area, a midfoot area, and a heel area;
wherein the joint portion comprises at least one first joint in the forefoot area and at least one second joint in the heel area.

36. The article of any one of the previous aspects, wherein the joint portion extends along at least 20%, optionally at least 40%, optionally at least 60% of the side of the midsole.

37. The article of any one of the previous aspects,
wherein the insole further comprises a cushioning layer that is provided on the top surface of the support layer; and/or
wherein an inlay is provided above the insole.

38. The article of any one of the previous aspects, wherein the support layer comprises two or more rigid plates, wherein the two or more rigid plates are connected via one or more articulations.

39. The article of any one of the previous aspects, wherein the support layer comprises one or more rigid plates, the plates optionally having cutouts, holes, or points of articulation.

40. The article of any one of the previous aspects, wherein the compression portion comprises a foam material, a spring material, a resilient polymer network, a 3D printed mesh and/or a damping material, such as a gel or an air cushion.

41. The article of any one of the previous aspects, wherein the joint portion is positioned within 3 cm from the edge of the midsole, optionally within 2 cm, optionally within 1 cm.

Although the present invention has been described with reference to preferred embodiments, workers skilled in the art will recognize that changes may be made in form and detail without departing from the spirit and scope of the invention.

1. An article of orthopedic footwear having a sole, the sole comprising:
an outsole which forms at least a portion of a ground-contacting surface of the footwear article;
an insole comprising a support layer for supporting a foot of a user; and
a midsole positioned between the support layer and the outsole and comprising
a compression portion having a first hardness and being positioned below a lower surface of the support layer; and
a joint portion having a second hardness greater than the first hardness and being positioned on one of a medial side and a lateral side of the lower surface of the support layer, the joint portion being configured to allow the support layer to pivot about the joint portion when subjected to a locomotion force such that the compression portion is compressed,
wherein the joint portion defines a pivot axis extending along the medial side of the midsole, the pivot axis being positioned within 3 cm of a medial edge of the midsole, or wherein the joint portion defines a pivot axis extending along the lateral side of the midsole, the pivot axis being positioned within 3 cm of a lateral edge of the midsole, and
wherein the support layer pivots about the pivot axis.

2. The article of claim 1, wherein the joint portion has a hardness of at least 80 Shore A.

3. The article of claim 1, wherein the joint portion is positioned such that the support layer is enabled to pivot in a medial-lateral direction.

4. The article of claim 1
wherein the support layer is more stiff than the midsole.

5. The article of claim 1, wherein the compression portion has a hardness of between 10 Shore A and 90 Shore A.

6. The article of claim 1,
wherein the support layer defines a support plane, wherein the support plane has a neutral position when the support layer is not subjected to a locomotion force, and wherein the article is configured such that, when the support layer is subjected to a locomotion force, the support plane pivots by a pivoting angle of at least 1° from the neutral position.

7. The article of claim 6, wherein the locomotion force is between 400 N and 6000 N.

8. The article of claim 6, wherein when a standing force of between 150 N and 700 N is applied to the support layer during standing of a person, the standing force causes the support plane to pivot by a pivoting angle of at most 10°.

9. The article of claim 6, wherein the joint portion defines a pivot axis, and wherein the support plane pivots by the pivoting angle about the pivot axis.

10. The article of claim 1, wherein, when the support layer is subjected to the locomotion force, the pivoting angle is within a range of 1° to 20°.

11. The article of claim 1, wherein the compression portion and the joint portion are formed from a single midsole material.

12. The article of claim 1, wherein the midsole further comprises a connecting portion positioned between the joint portion and the compression portion, the connecting portion having a third hardness which is less than the first hardness.

13. The article of claim 1, wherein the compression portion or the joint portion comprise two or more spaced apart segments.

14. An orthopedic shoe insert comprising:
an insole comprising a support layer for supporting a foot of a user; and
a midsole positioned adjacent to the support layer, the midsole comprising:
a compression portion having a first hardness; and
a joint portion having a second hardness greater than the first hardness and being positioned on one of a medial side and a lateral side of the lower surface of the support layer, the joint portion being configured to allow the support layer to pivot about the joint portion when subjected to a locomotion force such that the compression portion is compressed,
wherein the joint portion defines a pivot axis extending along the lateral or medial side of the midsole and the support layer pivots about the pivot axis, and wherein the pivot axis is positioned within 3 cm of an edge of the midsole.

15. The orthopedic shoe insert of claim 14, wherein the joint portion, the compression portion and the support layer are manufactured by 3D printing.

16. A method for adjusting the article of claim 1, the method including the steps of:
evaluating the locomotion of a person; and
positioning the joint portion and compression portion within the midsole and adjusting the hardness of the compression portion so as to modify biomechanics of a knee during locomotion.

17. The article of claim 1, wherein the pivot axis is positioned within 1 cm of a lateral edge of the midsole or wherein the pivot axis is positioned within 1 cm of a medial edge of the midsole.

18. The article of claim 1, wherein the support layer is at least as stiff as the joint portion.

19. The article of claim 1, wherein the locomotion force is applied to at least one of a forefoot area, a midfoot area, or a heel area of the support layer.

20. The article of claim 1, wherein the locomotion force is applied during a stride of a person.

21. The article of claim 1, wherein the joint portion and the compression portion are manufactured by 3D printing.
